(19) United States
(12) Patent Application Publication
(10) Pub. No.: US 2017/0213085 A1
(43) Pub. Date: Jul. 27, 2017

(54) SEE-THROUGH SMART GLASSES AND SEE-THROUGH METHOD THEREOF

(71) Applicant: SHENZHEN INSTITUTES OF ADVANCED TECHNOLOGY CHINESE ACADEMY OF SCIENCES, Shenzhen (CN)

(72) Inventors: Nan FU, Shenzhen (CN); Yaoqin XIE, Shenzhen (CN); Yanchun ZHU, Shenzhen (CN); Shaode YU, Shenzhen (CN); Zhicheng ZHANG, Shenzhen (CN)

(21) Appl. No.: 15/328,002

(22) PCT Filed: Dec. 15, 2015
(86) PCT No.: PCT/CN2015/097453

§ 371 Date: Jan. 20, 2017

(30) Foreign Application Priority Data
Sep. 21, 2015 (CN) 2015106025967

(51) Int. Cl. G06K 9/00; G06T 19/00; G06T 7/33; G06K 9/46; G06T 7/73

(52) U.S. Cl. CPC G06K 9/00671; G06K 9/4604; G06T 7/75; G06T 7/344; G06T 19/006; G06T 2207/30204

(57) ABSTRACT

Disclosed is see-through smart glasses (100) and see-through methods thereof. The see-through smart glasses (100) includes a model storing module (110), an image processing module (130) and an image displaying module (120). The model storing module (110) is used for storing a 3D model of a target; the image processing module (130) is used for identifying target extrinsic marker (210′) of the target (200) based on a user's viewing angle, find out a spatial correlation between the target extrinsic marker (210′) and internal structure (220) based on the 3D model of the target (200), and generating an interior image of the target (200) corresponding to the viewing angle based on the spatial correlation; and the image displaying module (120) is used for displaying the interior image. With the present application, on the premise of not breaking a surface and an entire structure of a target, an internal structure (220) image corresponding to the user's viewing angle can be generated, so that the user can observe the internal structure of the object correctly, intuitively and visually with ease.

### TECHNICAL FIELD

The present application relates to smart glasses, especially to a see-through smart glasses and a see-through method thereof.

### BACKGROUND ART

With the advances in electronic technology, smart glasses, such as googleglass and Epson Moverio BT-200 smart glasses, have been developed progressively. Like a smart phone, a pair of available smart glasses has an independent operating system. It can be installed by a user with programs like software, games and other provided by software service providers. It may also have functions of adding schedule, map navigation, interacting with friends, taking pictures and videos, and video calling with friends which can be achieved by voice or motion control. Moreover, it may have wireless internet access through mobile communication network.

A drawback of the available smart glasses is that: the user could not see through an object with the smart glasses. Accordingly, it is not convenient for the user to correctly, intuitively and visually understand the internal structure of the object.

### SUMMARY OF THE INVENTION

The present application provides see-through smart glasses and see-through methods thereof.

The present application may be achieved in that: providing a see-through smart glasses including a model storing module, an image processing module and an image displaying module, the model storing module being used for storing a 3D model of a target; the image processing module being used for identifying target extrinsic marker of the target based on a user's viewing angle, find out a spatial correlation between the target extrinsic marker and internal structure based on the 3D model of the target, and generating an interior image of the target corresponding to the viewing angle based on the spatial correlation; and the image displaying module being used for displaying the interior image.

A technical solution employed in an embodiment of the present application may further include that: the image processing module may include an image capturing unit and a correlation establish unit, the image displaying module may display an surface image of the target based on the user's viewing angle, the image capturing unit may capture the surface image of the target, extract feature points with a feature extracting algorithm, and identify the target extrinsic marker of the target; and the correlation establish unit may establish the spatial correlation between the target extrinsic marker and the internal structure based on the 3D model of the target, and calculate rotation and transformation of the target extrinsic marker.

The technical solution employed in an embodiment of the present application may further include that: the image processing module may further include an image generating unit and an image overlaying unit; the image generating unit may be used for generating the interior image of the target based on the rotation and transformation of the target extrinsic marker and projecting the image; and the image overlaying unit may be used for displaying the projected image in the image displaying module, and replacing the surface image of the target with the projected stereo interior image.

The technical solution employed in an embodiment of the present application may further include that: the 3D model of the target may include an external structure and the internal structure of the target, the external structure may be an externally visible part of the target and includes marker of the target, the internal structure may be an internally invisible part of the target and may be used for usage in see-through display, the external structure of the target may be performed with a transparentizing process when seeing through the internal structure; an establishing mode of the 3D model may include: providing by modeling a manufacturer of the target, modeling based on a specification of the target, or generating based on a scanning result of X ray, CT and a Magnetic Resonance device; and the 3D model is imported to the model storing module to be stored.

The technical solution employed in an embodiment of the present application may further include that: the image displaying module may be a smart glasses display screen, an image display mode may include monocular display or binocular display; the image capturing unit may be a camera of the smart glasses, and the feature points of the surface image of the target may include an external appearance feature or a manually labeled pattern feature of the target.

The technical solution employed in an embodiment of the present application may further include that: a calculating method for the correlation establish unit calculating the rotation and transformation of the target extrinsic marker may include that: a process of the image processing module identifying the target extrinsic marker of the target based on the user's viewing angle, find out the spatial correlation between the target extrinsic marker and the internal structure based on the 3D model of the target, and generating the interior image of the target corresponding to the viewing angle based on the spatial correlation includes: capturing a target extrinsic marker image, comparing the target extrinsic marker image with a known marker image of the 3D model of the target to obtain an observation angle, projecting the entire target from the observation angle, performing an image sectioning operation at a position at which the target extrinsic marker image locates, and replacing the surface image of the target with the obtained sectioned image, thus obtaining a perspective effect.

Another technical solution employed in an embodiment of the present application may include that: providing a see-through method for see-through smart glasses which may include:

step a: establishing a 3D model based on an actual target, and storing the 3D model through the smart glasses;

step b: identifying target extrinsic marker of the target based on a user's viewing angle, find out a spatial correlation between the target extrinsic marker and an internal structure based on the 3D model of the target; and

step c: generating an interior image of the target corresponding to the viewing angle based on the spatial correlation, and displaying the interior image through the smart glasses.

The technical solution employed in an embodiment of the present application may further include that: the step b may further include: computing rotation and transformation of the target extrinsic marker; a calculation method for the rotation and transformation of the target extrinsic marker may include: when considering an approximation of the target extrinsic marker partially to be a plane, capturing at least four feature points, performing alignment and transform on the target extrinsic marker of the target with a known marker, calculating a 3*3 transformation matrix T1 during establishment of the spatial correlation; estimating a position of a display screen seen by eyes, calculating a correction matrix T3 transformed between an image from a camera and an eyesight image, combining the transformation matrix T1 with the known correction matrix T3 to obtain a matrix T2 of the position at which the display screen locates, calculating angle and transformation corresponding to the matrix T2 which are the rotation and transformation of the target extrinsic marker.

The technical solution employed in an embodiment of the present application may further include that: in the step c, the process of generating the interior image of the target (200) corresponding to the viewing angle based on the spatial correlation and displaying the interior image through the smart glasses may include: generating the interior image of the target based on the rotation and transformation of the target extrinsic marker and projecting the image, displaying the projected image in the smart glasses, and replacing a surface image with the projected image of the target.

The technical solution employed in an embodiment of the present application may further include that: after the step c, the method for see-through smart glasses may further include: when the captured surface image of the target changes, judging whether there is an overlapped target extrinsic marker image at the surface image and an identified target extrinsic marker image, if yes, reperforming the step b at a neighboring region of the identified target extrinsic marker image, if no, reperforming the step b to the entire image.

With the see-through smart glasses and the see-through method thereof in the present application, a 3D model of the target can be established on the premise of not breaking a surface and an entire structure of a target, and after a user wears the smart glasses, an internal structure image of the target corresponding to the user's viewing angle can be generated by the smart glasses, so that the user can observe the internal structure of the object correctly, intuitively and visually with ease.

### BRIEF DESCRIPTION OF THE DRAWINGS

FIG. 1 is a schematically structural diagram of see-through smart glasses in an embodiment of the present application;

FIG. 2 is a schematically structural diagram of a target;

FIG. 3 is a schematic effect diagram of the target viewed from outside;

FIG. 4 is a schematic diagram showing correction relationship between a camera and a display;

FIG. 5 is a schematic flow diagram of a see-through method for see-through smart glasses in an embodiment of the present application.

### DETAILED DESCRIPTION

### First Embodiment

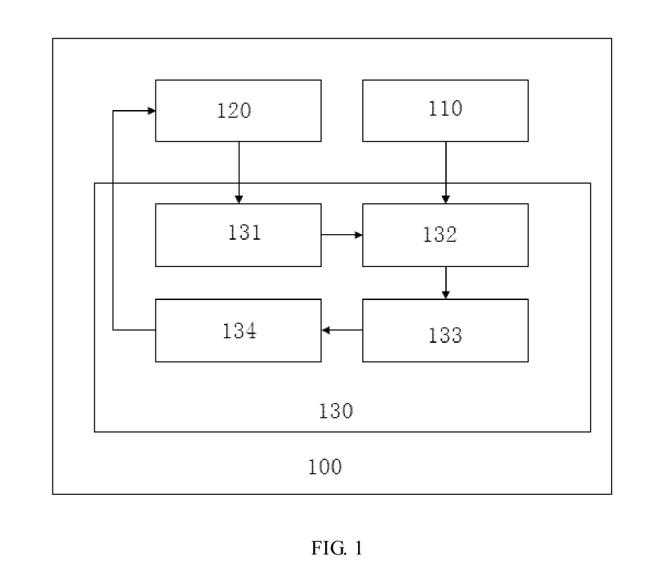

Referring to FIG. 1, a structure of see-through smart glasses in the embodiment of the present application is schematically shown. The see-through smart glasses 100 in the embodiment of the present application may include a model storing module 110, an image displaying module 120 and an image processing module 130, which is described in details as below.

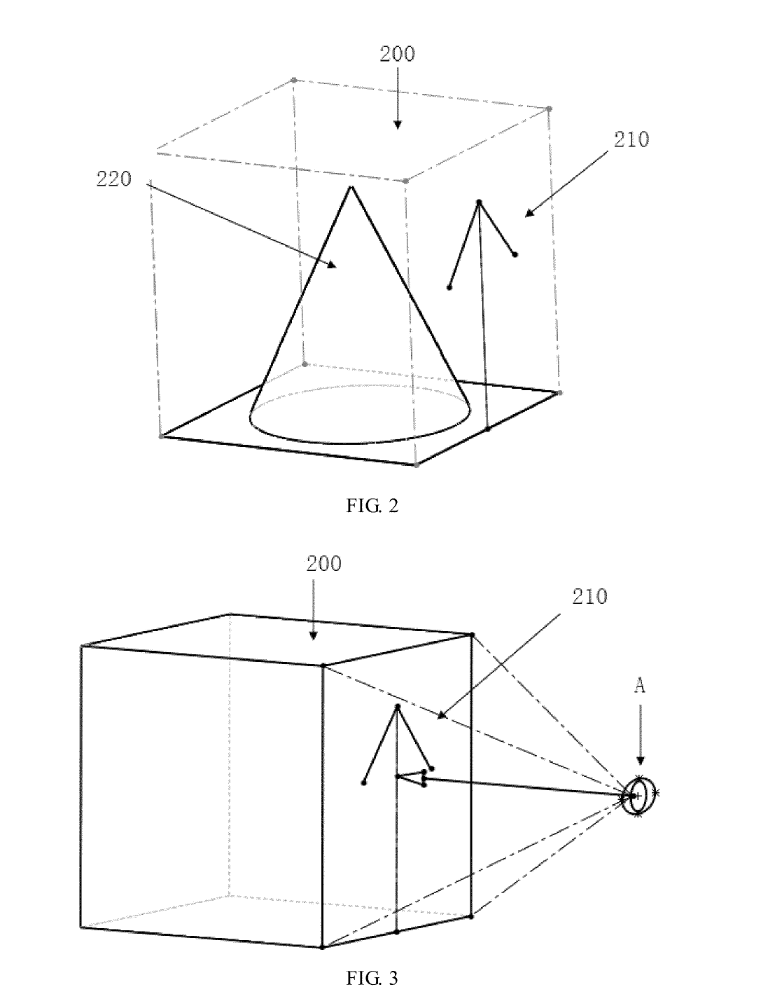

The model storing module 110 may be used for storing a 3D model of a target. The 3D model of the target may include an external structure and the internal structure 220 of the target. The external structure may be an externally visible part of the target 200 and may include marker 210′ of the target. The internal structure 220 may be an internally invisible part of the target and may be used for usage in see-through display. The external structure of the target may be performed with a transparentizing process when the internal structure 220 is got by seeing through. An establishing mode of the 3D model may include: providing by modeling a manufacturer of the target 200, modeling based on a specification of the target, or generating based on a scanning result of X ray, CT and a Magnetic Resonance device; or other modeling mode except the aforesaid modes. The 3D model may be imported to the model storing module 110 to be stored. For more details, refers to FIG. 2 schematically showing a structure of the target 200.

Marker 210 is existed in the 3D of the target. The marker 210 may be a standard image of the normalized target extrinsic marker 210′. The target extrinsic marker 210′ may be images of the marker under different rotation and transformation in terms of the marker 210.

The image displaying module 120 may be used for displaying a surface image or an interior image of the target 200 based on a user's viewing angle. The image displaying module 120 may be a smart glasses display screen. An image display mode may include monocular display or binocular display. The image displaying module 120 may allow natural lights to penetrate, so that the user can see a natural view when viewing images displayed by the smart glasses, which is a traditional see-through mode; or the image displaying module 120 may not allow the natural lights to penetrate, which is a traditional block mode.

The image processing module 130 may be used for identifying target extrinsic marker 210′ of the target 200, find out a spatial correlation between the target extrinsic marker 210′ and an internal structure 220, generating the interior image of the target 200 corresponding to the viewing angle based on the spatial correlation, and displaying the interior image through the image displaying module 120. Specifically, the image processing module 130 may include an image capturing unit 131, a correlation establish unit 132, an image generating unit 133 and an image overlaying unit 134.

The image capturing unit 131 may be used for capturing the surface image of the target 200, extracting feature points with a feature extracting algorithm, and identifying the target extrinsic marker 210′ of the target 200. In the embodiment, the image capturing unit 131 may be a camera of the smart glasses. The feature points of the surface image of the target 200 may include an external appearance feature or a manually labeled pattern feature of the target 200. Such feature points may be captured by the camera of the smart glasses and identified by corresponding feature extracting algorithm. For more details, refers to FIG. 3 schematically showing an effect diagram of the target 200 viewed from outside, wherein A is the user's viewing angle. After identifying the target extrinsic marker 210′, since the target extrinsic marker 210′ in two adjacent frames in a video may be overlapped partially, it may be easier to recognize the target extrinsic marker 210′ in the following frames of the video.

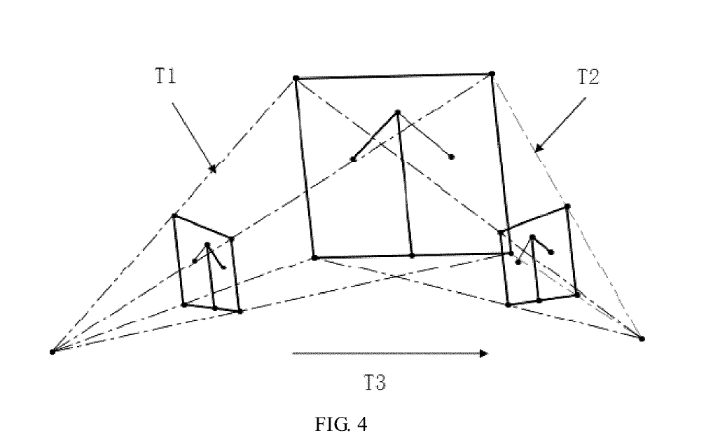

The correlation establish unit 132 may be used for establishing a spatial correlation between the target extrinsic marker 210′ and the internal structure 220 according to the 3D model of the target 200 and the marker 210 on the model, and calculating rotation and transformation of the target extrinsic marker 210′. Specifically, a method for calculating the rotation and transformation of the target extrinsic marker 210′ may include: when considering an approximation of the target extrinsic marker partially to be a plane, capturing at least four feature points, comparing target extrinsic marker 210′ of the target 200 with a known marker 210, and calculating a 3*3 transformation matrix T1 during establishment of the spatial correlation. Since the position at which the camera of the smart glasses locates and the position of the display screen seen by eyes fail to overlap completely, it is need to estimate a position of the display screen seen by eyes, and at the same time, calculate a correction matrix T3 transformed between an image from a camera and an eyesight image, where T3=T2⁻¹T1. The transformation matrix T1 may be combined with the known correction matrix T3 to obtain a matrix T2 of the position at which the display screen locates. Then the angle and transformation corresponding to the matrix T2, which are the rotation and transformation of the target extrinsic marker 210′, may be calculated. For more details, refers to FIG. 4 schematically showing correction relationship between the camera and the display.

In the present application, the correction matrix T3, which is determined by parameters of the apparatus itself and regardless of the user and the target 200. The correction matrix T3 of the apparatus can be obtained by camera calibration technique. A detailed method for the correction matrix T3 may be as follow. As the position of an image captured by the camera is not a position of the image directly observed by eyes, there may be an error when applying the matrix captured and calculated by the camera to the camera in front of the eyes. To reduce the error, the correction matrix T3 is established wherein the matrix may represent a minor deviation between the camera and the display seen by eyes. As a relative position between the display of the apparatus and the camera may not be changed normally, the correction matrix T3 may only depend on parameters of the apparatus itself, and can be determined by a spatial correlation between the display of the apparatus and the camera, regardless of other factors. A specific method for calculating the correction matrix T3 is that: using a standard calibration board for the target, replacing the display with another camera, and comparing images obtained by the two cameras with an image of the standard calibration board and directly obtaining the transformation matrix T1′ and T2′ (here using T1′ and T2′ for avoiding confusion), thus calculating the correction matrix T3 through a formula T3=T2′⁻¹T1′. T3 is determined by parameters of the apparatus, regardless of images captured by the camera, and different apparatus parameters may correspond to different T3.

The image generating unit 133 may be used for generating the interior image of the target 200 in accordance with the rotation and transformation of the target extrinsic marker 210′ and projecting the interior image.

The image overlaying unit 134 may be used for displaying the projected image in the image displaying module 120, and replacing the surface image of the target 200 with the projected image, so as to obtain an effect of seeing through the target 200 to get the internal structure 220; which mean: capturing a target extrinsic marker 210′ image by the image capturing unit 131, comparing the target extrinsic marker 210′ image with a known marker 210 image of the 3D model of the target 200 to obtain an observation angle, projecting the entire target 200 from the observation angle, performing an image sectioning operation at a position at which the target extrinsic marker 210′ image locates, and replacing the surface image of the target 200 with the obtained sectioned image, thus obtaining a perspective effect. At the moment, the image seen by the user through the image displaying module 120 may be a result of integrating and superimposing the surface image of the target 200 with the projected image generated by the image generating unit 133. Since part of the surface image of the target 200 is covered by the projected image and replaced by a perspective image of the internal structure 220 of the target 200 under the angle, from the point of view of the user wearing the smart glasses, the outer surface of the target is transparent, achieving an effect of seeing through the target 200 to get the internal structure 220. An image display mode may include completely displaying videos, or only projecting the internal structure 220 of the target 200 on the image displaying module 120. It could be understood that, in the present application, not only the internal structure 220 of an object can be displayed, patterns or other three-dimensional virtual images which are not exists actually can also be shown on the surface of the target simultaneously.

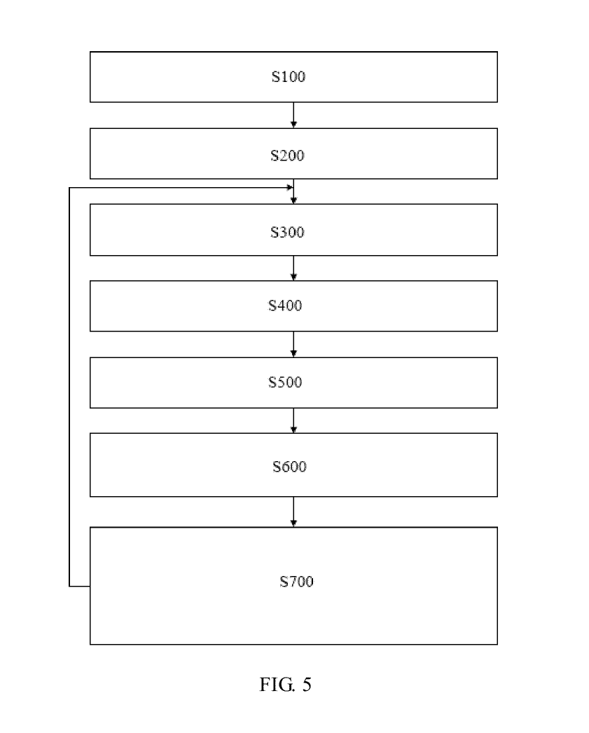

Referring to FIG. 5, a flow diagram of a see-through method for see-through smart glasses in the embodiment of the present application is schematically shown. The see-through method for see-through smart glasses in the embodiment of the present application may include the following steps.

Step 100: establishing a 3D model based on an actual target 200, and storing the 3D model through the smart glasses.

In the step 100, the 3D model may include an external structure and the internal structure 220 of the target 200. The external structure may be an externally visible part of the target 200 and may include marker 210 of the target 200. The internal structure 220 may be an internally invisible part of the target 200 and may be used for usage in see-through display. The external structure of the target 200 may be performed with a transparentizing process when the internal structure 220 is got by seeing through. An establishing mode of the 3D model of the target 200 may include: providing by modeling a manufacturer of the target 200, modeling based on a specification of the target 200, or generating based on a scanning result of X ray, CT and a Magnetic Resonance device; or other modeling mode except the aforesaid modes. For more details, refers to FIG. 2 schematically showing a structure of the target 200.

Step 200: wearing the smart glasses, displaying the surface image of the target 200 through the image displaying module 120 based on the user's viewing angle.

In step 200, the image displaying module 120 may be a smart glasses display screen. An image display mode may include monocular display or binocular display. The image displaying module 120 may allow natural lights to penetrate, so that the user can see a natural view when viewing images displayed by the smart glasses, which is a traditional see-through mode; or the image displaying module 120 may not allow the natural lights to penetrate, which is a traditional block mode.

Step 300: capturing the surface image of the target 200, extracting feature points with a feature extracting algorithm, and identifying the target extrinsic marker 210′ of the target 200.

In step 300, the feature points of the surface image of the target 200 may include an external appearance feature or a manually labeled pattern feature of the target 200. Such feature points may be captured by the camera of the see-through smart glasses 100 and identified by corresponding feature extracting algorithm. For more details, refers to FIG. 3 schematically showing an effect diagram of the target 200 viewed from outside

Step 400: establishing a spatial correlation between the target extrinsic marker 210′ and the internal structure 220 according to the 3D model of the target 200, and calculating rotation and transformation of the target extrinsic marker 210′.

In step 400, a method for calculating the rotation and transformation of the target extrinsic marker 210′ may include: when considering an approximation of the target extrinsic marker partially to be a plane, capturing at least four feature points, comparing target extrinsic marker 210′ of the target 200 with a known marker 210, and calculating a 3*3 transformation matrix T1 during establishment of the spatial correlation. Since the position at which the camera of the smart glasses locates and the position of the display screen seen by eyes fail to overlap completely, it is need to estimate a position of the display screen seen by eyes, and at the same time, calculate a correction matrix T3 transformed between an image from a camera and an eyesight image. The transformation matrix T1 may be combined with the known correction matrix T3 to obtain a matrix T2 of the position at which the display screen locates. Then the angle and transformation corresponding to the matrix T2, which are the rotation and transformation of the target extrinsic marker 210′, may be calculated. For more details, refers to FIG. 4 schematically showing correction relationship between the camera and the display. In the present application, the correction matrix T3, which is determined by parameters of the apparatus itself and regardless of the user and the target 200, may be obtained by means of marker means. The correction matrix T3 of the apparatus can be obtained by camera calibration technique.

Step 500: generating the interior image of the target 200 in accordance with the rotation and transformation of the target extrinsic marker 210′ and projecting the interior image.

Step 600: displaying the projected image in the image displaying module 120, and replacing the surface image of the target 200 with the projected image, so as to obtain an effect of seeing through the target 200 to get the internal structure 220.

In step 600, when displaying the projected image on the image displaying module 120, the image seen by the user through the image displaying module 120 may be a result of integrating and superimposing the surface image of the target 200 with the projected image generated by the image generating unit 133. Since part of the surface image of the target 200 is covered by the projected image and replaced by a perspective image of the internal structure 220 of the target 200 under the angle, from the point of view of the user wearing the smart glasses, the outer surface of the target is transparent, achieving an effect of seeing through the target 200 to get the internal structure 220. An image display mode may include completely displaying videos, or only projecting the internal structure 220 of the target 200 on the image displaying module 120. It could be understood that, in the present application, not only the internal structure 220 of an object can be displayed, patterns or other three-dimensional virtual images which are not exists actually can also be shown on the surface of the target simultaneously.

Step 700: when the captured surface image of the target 200 changes, judging whether there is an overlapped marker image 210 at the surface image and an identified target extrinsic marker 210′ image, if yes, reperforming the step 300 at a neighboring region of the identified target extrinsic marker 210′ image, if no, reperforming the step 300 to the entire image.

In step 700, the neighboring region of the identified target extrinsic marker 210′ image may be referred to be: the other region except from a region existed in the target extrinsic marker image at the surface image of the changed target 200 and the identified target extrinsic marker 210′ image, and the other region is connected with the identified target extrinsic marker 210′ region. After recognizing the target extrinsic marker 210′, as the target extrinsic marker images in two adjacent frames in a video may be overlapped partially, it may be easier to recognize the target extrinsic marker 210′ in the following frames of the video. When the target 200 or the user moved, the target extrinsic marker 210 of the target 200 may be re-captured to generate a new interior image and a process of image replacement may be performed, so that the observed images can be changed with the viewing angles, thus producing a realistic see-through impression.

With the see-through smart glasses and the see-through method thereof in the present application, a 3D model of the target can be established on the premise of not breaking a surface and an entire structure of a target, and after a user wears the smart glasses, an internal structure image of the target corresponding to the user's viewing angle can be generated by the smart glasses, so that the user can observe the internal structure of the object correctly, intuitively and visually with ease. In another embodiment of the present application, tracker technology may also be used for assisting, and the display result may be more intuitive and easy to use by means of tracking and displaying positions of a tracker located inside the target.

The foregoing descriptions of specific examples are intended to illustrate, appreciate and not to limit the present disclosure. Various changes and modifications may be made to the aforesaid embodiments by those skilled in the art without departing from the spirit of the present disclosure.

What is claimed is:

1. A see-through smart glasses, comprising a model storing module, an image processing module and an image displaying module, the model storing module being used for storing a 3D model of a target; the image processing module being used for identifying target extrinsic marker of the target based on a user's viewing angle, find out a spatial correlation between the target extrinsic marker and internal structure based on the 3D model of the target, and generating an interior image of the target corresponding to the viewing angle based on the spatial correlation; and the image displaying module being used for displaying the interior image.

2. The see-through smart glasses according to claim 1, wherein the image processing module comprises an image capturing unit and a correlation establish unit, the image displaying module displays an surface image of the target based on the user's viewing angle, the image capturing unit captures the surface image of the target, extracts feature points with a feature extracting algorithm, and identifies the target extrinsic marker of the target; and the correlation establish unit establishes the spatial correlation between the target extrinsic marker and the internal structure based on the 3D model of the target, and calculates rotation and transformation of the target extrinsic marker.

3. The see-through smart glasses according to claim 2, wherein the image processing module further comprises an image generating unit and an image overlaying unit; the image generating unit is used for generating the interior image of the target based on the rotation and transformation of the target extrinsic marker and projecting the image; and the image overlaying unit is used for displaying the projected image in the image displaying module, and replacing the surface image of the target with the projected image.

4. The see-through smart glasses according to claim 1, wherein the 3D model of the target comprises an external structure and the internal structure of the target, the external structure is an externally visible part of the target and includes marker of the target, the internal structure is an internally invisible part of the target and is used for usage in see-through display, the external structure of the target is performed with a transparentizing process when the internal structure is got by seeing through; an establishing mode of the 3D model comprises: providing by modeling a manufacturer of the target, modeling based on a specification of the target, or generating based on a scanning result of X ray, CT and a Magnetic Resonance device; and the 3D model is imported to the model storing module to be stored.

5. The see-through smart glasses according to claim 2, wherein the image displaying module is a smart glasses display screen, an image display mode includes monocular display or binocular display; the image capturing unit is a camera of the smart glasses, and the feature points of the surface image of the target includes an external appearance feature or a manually labeled pattern feature of the target.

6. The see-through smart glasses according to claim 1, wherein a process of the image processing module identifying the target extrinsic marker of the target based on the user's viewing angle, find out the spatial correlation between the target extrinsic marker and the internal structure based on the 3D model of the target, and generating the interior image of the target corresponding to the viewing angle based on the spatial correlation includes: capturing a target extrinsic marker image, comparing the target extrinsic marker image with a known marker image of the 3D model of the target to obtain an observation angle, projecting the entire target from the observation angle, performing an image sectioning operation at a position at which the target extrinsic marker image locates, and replacing the surface image of the target with the obtained sectioned image, thus obtaining a perspective effect.

7. A see-through method for see-through smart glasses, comprising:
step a: establishing a 3D model based on an actual target, and storing the 3D model through the smart glasses;
step b: identifying target extrinsic marker of the target based on a user's viewing angle, find out a spatial correlation between the target extrinsic marker and an internal structure based on the 3D model of the target; and
step c: generating an interior image of the target corresponding to the viewing angle based on the spatial correlation, and displaying the interior image through the smart glasses.

8. The see-through method for see-through smart glasses according to claim 7, wherein the step b further comprises: computing rotation and transformation of the target extrinsic marker; a calculation method for the rotation and transformation of the target extrinsic marker includes: when considering an approximation of the target extrinsic marker partially to be a plane, capturing at least four feature points, performing alignment and transform on the target extrinsic marker of the target with a known marker, calculating a 3*3 transformation matrix T1 during establishment of the spatial correlation; estimating a position of a display screen seen by eyes, calculating a correction matrix T3 transformed between an image from a camera and an eyesight image, combining the transformation matrix T1 with the known correction matrix T3 to obtain a matrix T2 of the position at which the display screen locates, calculating angle and transformation corresponding to the matrix T2 which are the rotation and transformation of the target extrinsic marker.

9. The see-through method for see-through smart glasses according to claim 7, wherein in the step c, the process of generating the interior image of the target corresponding to the viewing angle based on the spatial correlation and displaying the interior image through the smart glasses includes: generating the interior image of the target based on the rotation and transformation of the target extrinsic marker and projecting the image, displaying the projected image in the smart glasses, and replacing the projected image with a surface image of the target.

10. The see-through method for see-through smart glasses according to claim 9, after the step c, further comprising: when the captured surface image of the target changes, judging whether there is an overlapped target extrinsic marker image at the surface image and an identified target extrinsic marker image, if yes, repeating the step b at a neighboring region of the identified target extrinsic marker image, if no, repeating the step b to the entire image.
